(19) United States
(12) Patent Application Publication
(10) Pub. No.: US 2014/0172679 A1
(43) Pub. Date: Jun. 19, 2014

(54) Systems And Methods Of An Online Secured Loan Manager

(71) Applicant: CreditCircle Inc., Salt Lake City, UT (US)

(72) Inventor: David Shimko, New York, NY (US)

(73) Assignee: CreditCircle Inc., Salt Lake City, UT (US)

(21) Appl. No.: 13/717,183

(22) Filed: Dec. 17, 2012

(51) Int. Cl. G06Q 40/02

(52) U.S. Cl. CPC G06Q 40/025
USPC 705/38

(57) ABSTRACT

Systems and methods of an online secured loan manager (“OSLM system”) that facilitates a sponsor network secured lending transaction. The OSLM system allows divided sponsoring and divided lending to create and provide a secured loan product having reduced risk and lower interest rate than an unsecured loan product. The OSLM system processes a loan request from a borrower by creating a sponsor network for the borrower using the borrower's social connections. The sponsor network provides collateral pledges that are used to secure the loan for the borrower. The OSLM system further facilitates funding of the secured loan by matching the secured loan to a lender.

### BACKGROUND

Existing online lending sites allow borrowers to obtain unsecured personal loans. Such sites usually require borrowers to meet certain stringent requirements such as a minimum credit score (e.g., FICO score of 660) to qualify for unsecured personal loans. Some existing online lending sites also allow lenders to provide funds for the personal loans in exchange for a return. However, like the borrowers, the lenders also have to meet certain stringent requirements such as minimum annual gross income, minimum liquid net worth, etc., in order to qualify to be a lender of personal loans. Furthermore, as unsecured personal loans are inherently high risk, existing lending sites usually provide high interest rate to lenders, which results in high interest rates for borrowers.

### BRIEF DESCRIPTION OF THE DRAWINGS

FIG. 1A is a diagram illustrating an example environment in which the online secured loan manager system may be implemented.

FIG. 1B is a diagram illustrating an example architecture of the online secured loan manager system.

FIG. 2 is a diagram illustrating securing of portions of a loan by a plurality of sponsors in one embodiment of the online secured loan manager system.

FIG. 3 is a block diagram illustrating components of the online secured loan manager system.

FIGS. 4A-B is a logic flow diagram illustrating an exemplary method of loan request processing and sponsor selection in one embodiment of the online secured loan manager system.

FIG. 4C is a logic flow diagram illustrating an exemplary method of offering a secured loan to a lender in one embodiment of the online secured loan manager system.

FIG. 5 is a logic flow diagram illustrating an exemplary method of executing a secured loan transaction in one embodiment of the online secured loan manager system.

FIG. 6 is a data flow diagram illustrating processing of payments in one embodiment of the online secured loan manager system.

FIG. 7 is a logic flow diagram illustrating an exemplary method of managing default in one embodiment of the online secured loan manager system.

FIG. 8A is a diagram illustrating an exemplary sponsor finder user interface in one embodiment of the online secured loan manager system.

FIG. 8B is a diagram illustrating an exemplary user interface for investing in a secured loan in one embodiment of the online secured loan manager system.

FIG. 9 illustrates exemplary secured loans provided by the online secured loan manager system.

FIG. 10 is a diagram illustrating an exemplary systemization of the online secured loan manager server.

### DETAILED DESCRIPTION

An online secured loan manager (“OSLM”) system facilitates creation of a secured loan product. The OSLM system obtains collateral from multiple sponsors located through a borrower's social network and apportions the collateral from each sponsor to a fraction of the loan to create a secured loan product. The OSLM system, by leveraging the borrower's social network and allowing division of sponsorship or guarantee, allows borrowers to qualify for and obtain a loan, even if their creditworthiness as determined by credit agencies is low.

The OSLM system offers several advantages over existing lending programs. For example, the OSLM system qualifies borrowers for a secured loan based on the strength of their social network, and/or their ability to find sponsors willing to provide or pledge collateral. The secured loans provided by the OSLM system are low risk with low interest rates, and therefore more attractive to borrowers. Furthermore, the OSLM system, unlike existing lending programs, secures loans using the sponsors' collateral, such that the borrower's credit worthiness or lack of credit history does not prevent the borrower from qualifying for a secured loan. Besides borrowers who can qualify for secured loans with low interest rates, the OSLM system, in one embodiment, offers the sponsors a fee in return for providing the collateral. The OSLM system also allows lenders to purchase or invest in secured loan products.

Various implementations of the OSLM system and method will now be described. The following description provides specific details for a thorough understanding and an enabling description of these implementations. One skilled in the art will understand, however, that the invention may be practiced without many of these details. Additionally, some well-known structures or functions may not be shown or described in detail, so as to avoid unnecessarily obscuring the relevant description of the various implementations. The terminology used in the description presented below is intended to be interpreted in its broadest reasonable manner, even though it is being used in conjunction with a detailed description of certain specific implementations of the invention.

### Example Environment and Architecture

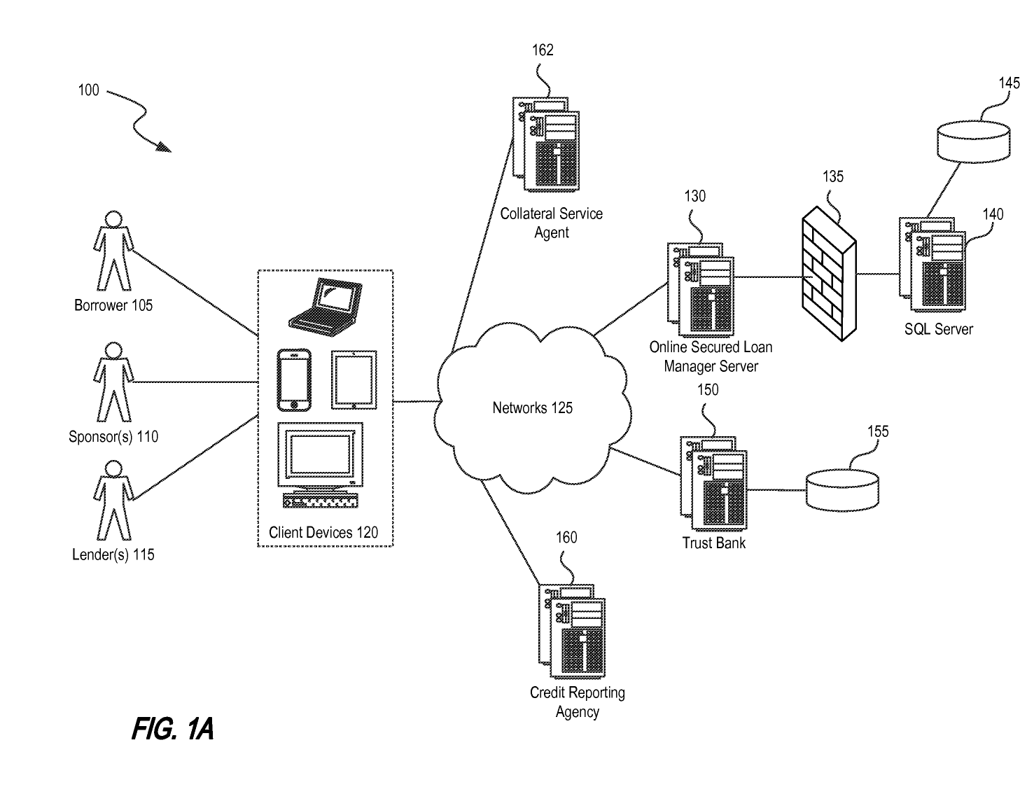

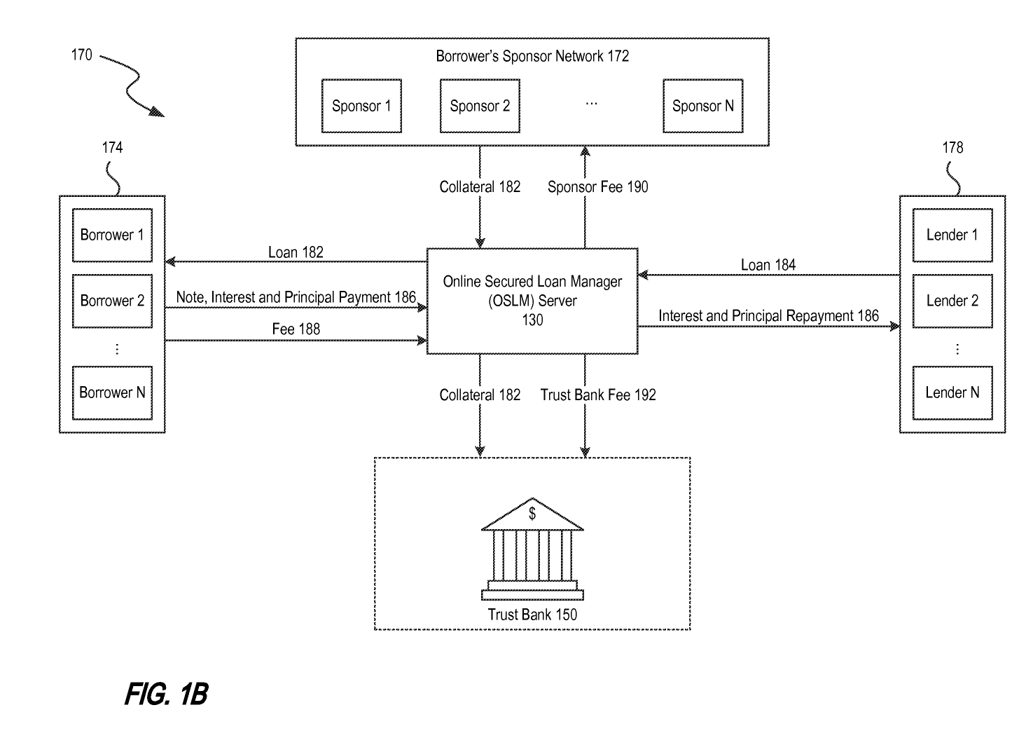

The OSLM system may be implemented in a suitable computing environment 100, such as the one shown in FIG. 1A. Although not required, aspects and implementations of the OSLM system will be described in the general context of computer executable instructions, such as routines executed by a general purpose computer, a personal computer, a server, or other computing systems.

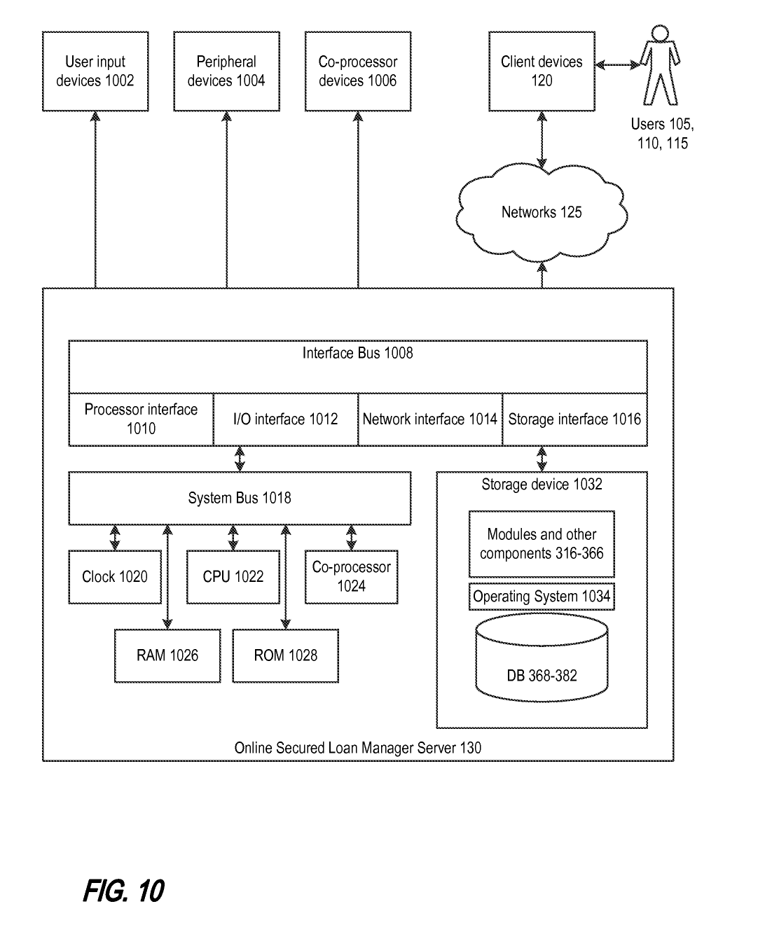

The OSLM system operates in environment 100. Client devices 120 such as, but not limited to, a computer, a laptop, a mobile phone, tablet, and the like, are used by borrowers 105, sponsors 110 and lenders 115 to access the web-based OSLM system hosted by server computers such as the OSLM server 130 over networks 125. Networks 125 may include wired and wireless networks, private networks and public networks (e.g., the Internet). Client devices 120 may use their network interfaces to connect to and/or communicate with networks 125, either directly, or via wireless routers, or cell towers. Network interfaces may employ connection protocols such as direct connect, Ethernet, wireless connection such as IEEE 802.11a-n, and the like to connect to networks 125. The OSLM server 130 is also connected to the network 125 to provide OSLM services. In one implementation, the OSLM server 130 may include a firewall 135 and a database server such as an SQL server 140 which is connected to or can access a database such as the database 145. Alternately, the firewall may be optional in some implementations. A diagrammatic representation of the OSLM server 130 is described in detail with respect to FIG. 10.

The OSLM server 130 may be connected to a trust bank 150 implemented as a server via the network 125. The trust bank 150 may be responsible for carrying out various instructions issued by the OSLM server 130. For example, the trust bank 150 maintains and/or holds collateral from sponsors, assists in collateral valuation, creates and maintains accounts for borrower 105, sponsor 110 and/or lender 115, and the like, in one implementation. The trust bank 150, in a further implementation, provides reports of assets held, collateral valuation, cash movements, loans outstanding, and the like. The trust bank 150 takes in payment from a borrower and disperses the payment as instructed by the OSLM server 130. In one implementation, the trust bank 150 may enter into a trust operating agreement with the OSLM system to assist the OSLM system in its functions in return for a fee. The trust bank 150 may be connected to one or more databases such as the database 155 to store account data.

The OSLM server 130 may communicate with a credit reporting agency 160 over the network 125. The OSLM server 130 may request the credit reporting agency 160 for credit reports to verify the borrower 105, the lender 115 and/or the sponsor 110. In the event of default, the OSLM server 130 may report the borrower to the credit reporting agency 160. The OSLM server 130 may also communicate with a collateral service agent 162 to obtain financial information on collateral assets for collateral valuation and monitoring. Examples of the collateral service agent 162 includes Bloomberg, Markit, and others.

The term “server” as used herein refers generally to a computer, device, program or combination thereof that processes and responds to requests from remote clients across a network. The term “client” as used herein refers generally to a computer, device, program or combination thereof that is capable of processing and making requests, obtaining and processing responses from servers via a network.

Referring to FIG. 1B, architecture 170 depicts participants of a secured lending transaction facilitated by the OSLM server 130. In order to facilitate a secured lending transaction, the OSLM server 130 interacts with a borrower 174. the borrower's sponsor network 172 that includes one or more sponsors (e.g., sponsors 1 to N), a plurality of lenders (e.g., lenders 1 to N) 178 and a trust bank 150 over a network. For example, the OSLM server 130 receives from the borrower's sponsor network 172, collateral 182 for a loan. The OSLM server 130 provides the collateral 182 to the trust bank 150. The OSLM server 130 also receives funds for the loan 184 from one or more lenders 178, and provides the loan 184 to the borrower 174. The OSLM server 130 receives executed note and periodic interest and principal payments 186 from the borrower 174. The OSLM server 130 provides the interest and principal payment 186 to the one or more lenders 178. The OSLM 176 also receives from the borrower a periodic fee payment 188, and distributes a portion of the fee payment to the borrower's sponsor network 172 as sponsor fee 190 and keeps the remaining portion of the fee payment as a transaction fee. The OSLM server 130 also provides the trust bank 150 a fee payment 192 for holding the collateral 182, managing the borrower, lender and sponsor accounts, and the like. In one implementation, the payment 186 is includes an authorization to withdraw funds from the borrower's account with the trust bank.

In one embodiment, the OSLM system may be structured as a special purpose vehicle (“SPV”) which is a bankruptcy remote company. All transactions and agreements (e.g., lender agreements, loan agreements, collateral agreements, trust agreements, etc.) where the OSLM is a counterparty are performed via the SPV. Although not shown, a third party trustee may also be a part of the OSLM architecture. The trustee may be responsible for overseeing various operations performed by the OSLM including collateral management.

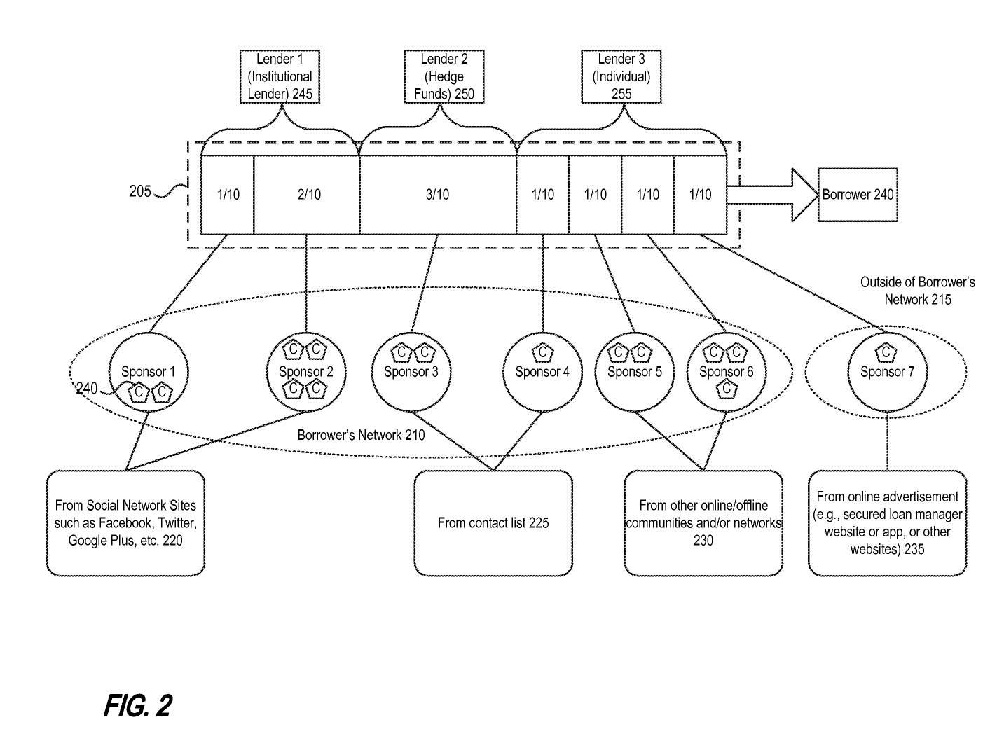

FIG. 2 is a diagram illustrating an example structure of a secured loan 205 that is provided to a borrower 240. The loan 205 may be secured by a plurality of sponsors (e.g., sponsors 1-6) from the borrower's network 210 and/or other sponsors (e.g., sponsor 7) from another network 215 that is outside of the borrower's network. All of the sponsors 1-7 together may constitute the borrower's sponsor network. In one embodiment, the loan 205 includes divisible guarantees, such that the loan can be divided into multiple portions and each such portion can be secured by collateral from a sponsor. For example, 1/10th of the loan 205 is secured using collateral (e.g., represented by reference numeral 240) put forward by sponsor 1. Similarly, 2/10th of the loan 205 is secured using collateral put forward by sponsor 2, and so on, until all of the loan 205 is secured in its entirety. The divisible guarantee aspect of the loan 205 reduces the obligation of each sponsor to a fraction of the loan for which the sponsor provided collateral.

Various types of collateral 240 may be used to secure each portion of the loan 205. The collateral 240 includes, but is not limited to: cash, equities, certificates of deposit, lines of credit, mutual funds, debt instruments, derivative instruments, foreign securities, real estate, hard assets, and the like. In one embodiment, the collateral 240 can include personal or soft guarantees.

The borrower's network 210 includes one or more sponsors that are located using the borrower's social connections. The network 210 may include online social and professional networks such as the Facebook, Twitter, Google Plus, Linked-in, and the like that the borrower is a member of. For example, sponsor 1 and sponsor 2 are shown in FIG. 1 as sponsors located through social network sites 220. Similarly, sponsors 3 and 4 in borrower's network 210 are identified or selected using the borrower's contact list or address book 225 which may include names, addresses, phone number, email, and other contact information of friends, acquaintances, colleagues, neighbors, and the like. Some sponsors (e.g., sponsors 5 and 6) may be located using other online/offline communities and/or networks 230. Examples of online/offline communities may include, but are not limited to: education related networks (e.g., high school, college, graduate school, etc., alumni or other networks, professional societies such as IEEE, SWE, and the like, cultural organizations, and the like. Some sponsors (e.g., sponsor 7) may be outside of the borrower's network, located by the OSLM system on behalf of the borrower using advertisement or other channels 235. The OSLM system may use, for example, online (or offline) advertisements, on the OSLM website and/or other websites to find one or more sponsors willing to provide collateral for securing one or more portions of the loan in exchange for a fee.

The loan 205 may be funded by one or more lenders (e.g., lenders 1-3). When funded by more than one lender, each lender may contribute funds towards a portion of the loan. For example, lender 1 funds 3/10th of the loan 205, lender 2 funds another 3/10th of the loan 205, and lender 3 funds ⅖th of the loan 205. The loan may be provided to the borrower 240 when it is fully funded by one or more lenders, and fully secured by one or more sponsors' collateral 240. Various types of lenders may fund the loan. By way of example only, lenders may include institutional lenders (e.g., lender 245), hedge funds (e.g., lender 250), individual lenders (e.g., lender 255), and the like. Lenders receive a fee or an interest on the principal in return for funding the loans.

### Example OSLM System

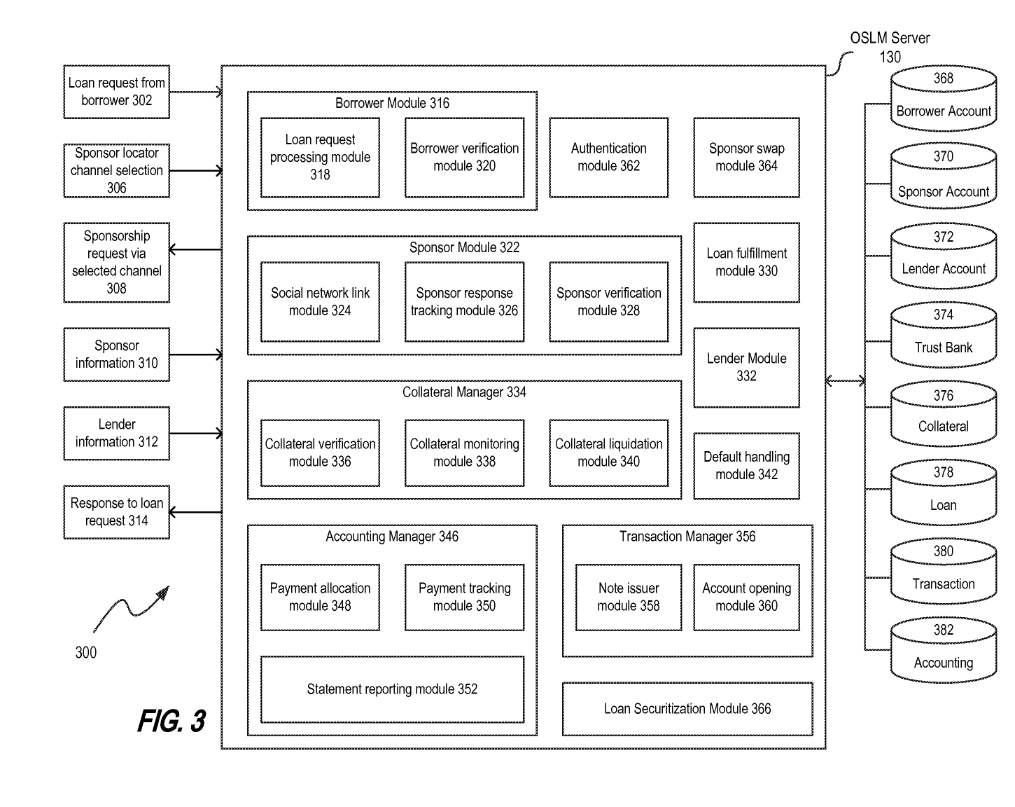

FIG. 3 is a block diagram of the modules or components in the OSLM system 300 and some of the data that is received, stored and transmitted by the system. The OSLM server 130 processes loan requests from borrowers and collects information relating to potential sponsors identified by the borrowers, or in some instances, by the OSLM server 130. For each loan request, the OSLM server 130 contacts the potential sponsors on the borrower's behalf to solicit a collateral pledge in return for a fee. When the value of the collateral pledged by the sponsors reaches a pre-determined threshold, the OSLM server 130 offers the secured loan for sale or investment to lenders in return for a fee. When the contribution from a lender meets the amount of the loan, the OSLM server 130 executes a secured lending transaction to transfer the loan amount from the lender to the borrower. After providing the loan to the borrower, the OSLM server 130 continues to monitor collateral values, manage payments, and take necessary steps to address collateral shortfall and/or default by the borrower, until the loan is repaid by the borrower.

Various inputs may be provided to the OSLM server 130 as part of the process for creating a secured loan product. For example, in one implementation, a loan request 302 may be received from a borrower. The loan request may be sent as a Secure HyperText Transfer Protocol (HTTP(S)) message and may be formatted in XML for example. The loan request 302 may include information relating to the loan such as, but not limited to: loan amount, loan period, purpose for borrowing, and the like. The loan request 302, in one implementation, may also include borrower information such as, but not limited to: name, address, social security number, telephone number, email address, and the like.

The loan request 302 may be processed by one or more OSLM server 130 modules such as a borrower module 316 having a loan request processing module 318 and a borrower verification module 320. The loan request processing module 318 may receive the loan request 302, and parse the loan request to extract details of the loan request. The loan request processing module 318 may provide the borrower information to the borrower verification module 320, which is responsible for verifying the information provided by the borrower. For example, the borrower verification module 320 may use the borrower's social security number to perform a background check on the borrower and/or obtain a credit report from one or more credit reporting agencies (e.g., 160). The borrower verification module 320 may also perform a phone verification based on the phone number provided. In some implementations, the borrower verification module 320 may verify the name, address, contact information, income, and the like, to ensure that the information provided by the borrower is correct.

The borrower verification module 320 provides the results of each verification performed to the loan request processing module 318, which in turn processes the verification results data to determine whether to put the loan request on hold or to move to the next phase of loan request processing. In one implementation, the determination may be based on one or more rules for evaluating the verification results. For example, one rule may specify that if any one verification step is incomplete, the loan request is put on hold until the incomplete verification step is completed. By way of another example, another rule may specify that if the age of the borrower is within 17 to 21, the occupation is student, credit score is at least 400, with an income source, the verification is successful. Various other rules for evaluating the verification results may be set up to facilitate the processing of the loan request. In one implementation, the loan request processing module 318 may generate an intermediate output (not shown) informing the borrower of the verification results.

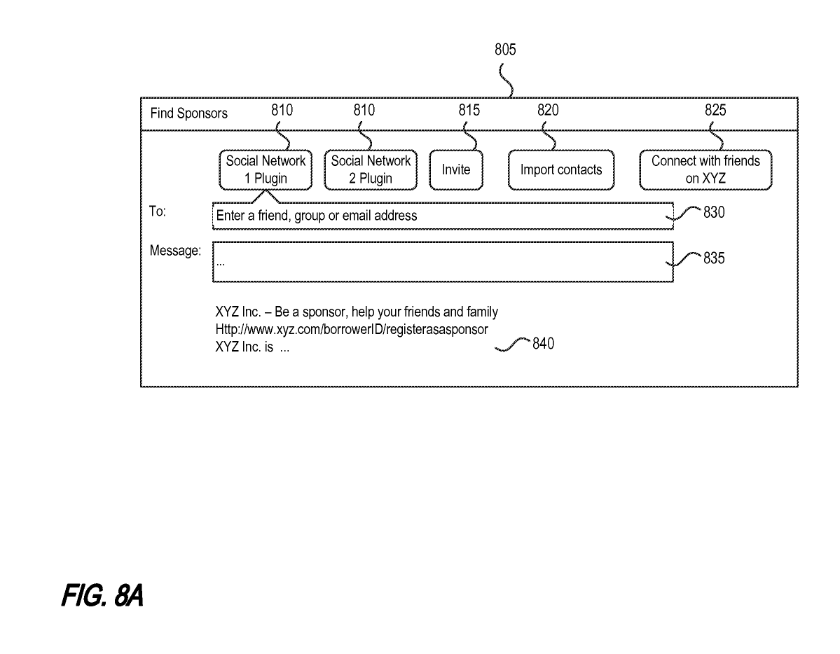

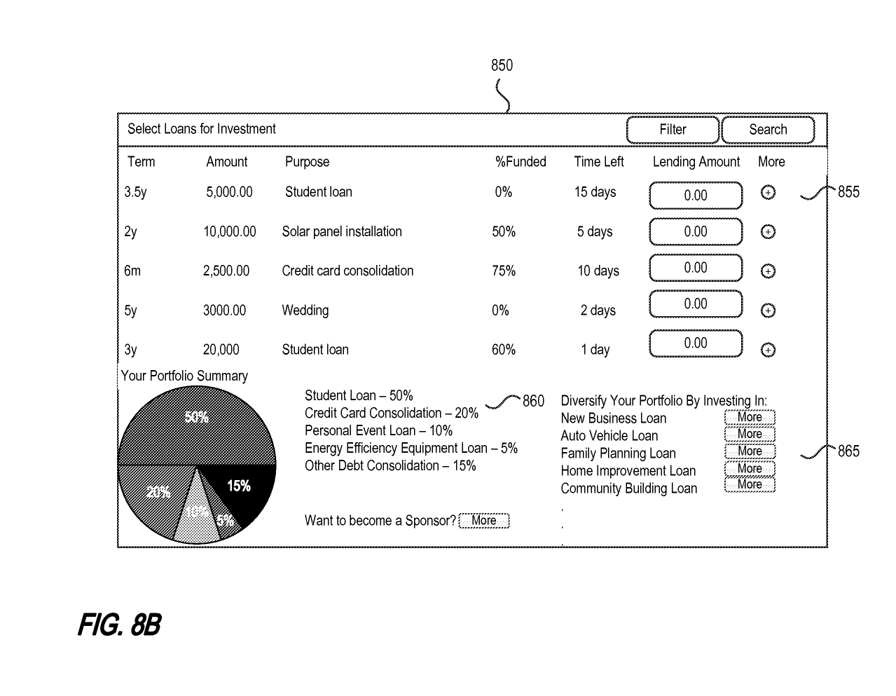

The OSLM server 130 may receive from the borrower a sponsor locator channel selection input 306. The sponsor locator channel selection 306 specifies one or more channels via which the OSLM system can send sponsorship requests. The sponsor locator channel selection 306 also can also include selections of potential sponsors for sending the sponsorship requests. Example channels for locating sponsors include, but are not limited to: social networks, email or SMS/MMS invites, contacts or address books, OSLM website, and the like. Examples of social networks include the Facebook, Twitter, LinkedIn, Google Plus, Skype, and the like. Contacts or address books may be imported from email services such as Gmail, Yahoo Mail, Hotmail, etc., mobile devices and/or other computing devices managing Personal Information Management (PIM) data. Invitation may be sent to specific individuals or groups via email, SMS/MMS, and the like. An example user interface for selecting the sponsor locator channels is shown in FIG. 8A.

A sponsor module 322 having a social network link module 324, a sponsor response tracking module 326 and a sponsor verification module 328 may be responsible for obtaining and/or processing the sponsor locator channel selection input 306. For example, the social network link module 324 may provide social network tools or plug-ins, contact importing tools, email, MMS/SMS and/or other messaging tools, and the like to allow the borrowers to select one or more sponsor locator channels, and from the selected sponsor locator channels, choose potential sponsors to send sponsorship requests. The social network link module 324 may also send auto-generated (e.g., from a template) or borrower-customized sponsorship requests 308 via the borrower selected channels to the selected potential sponsors.

The OSLM server 130 may receive a response from at least some of the sponsors receiving the sponsorship requests. Some sponsors may accept the sponsorship request, while others may decline the request. Those who accept the sponsorship request may provide sponsor information 310 to the OSLM server 130. The sponsor information may include identity information such as name, address, social security, email, phone, and the like. The sponsor information may also include information on the collateral that the sponsor is pledging to secure the borrower's loan.

The sponsor verification module 328, in one implementation, is responsible for verifying the sponsor information. For example, a background and/or credit check may be performed on the sponsors to verify their identity information, such as name, address, phone number, etc. The results of the verification may be provided to the sponsor response tracking module 326, in one implementation.

The sponsor response tracking module 326 may track, monitor and classify response to sponsorship requests from potential sponsors. For example, if 30 sponsorship requests were sent out to potential sponsors, the module may monitor the response status (e.g., request accepted, request declined, no response) for each sponsorship request. The module may then take appropriate actions based on the response status. In one implementation, for example, the module may periodically send a reminder to those potential sponsors who have not responded to the sponsorship request. The module may also track the verification status of each potential sponsor who accepted the request to, for example, include or exclude the potential sponsor from being a member of the borrower's sponsor network. For example, if the sponsor verification module 328 indicates that a potential sponsor cannot be verified because of a low credit score (e.g., a credit score below a certain threshold value), the sponsor response tracking module 326 may decline the potential sponsor's offer to provide collateral and exclude the potential sponsor from joining the borrower's sponsor network. The sponsor response tracking module 326, in coordination with the collateral manager 334, may further filter out potential sponsors with collateral that cannot be verified or that do not meet collateral verification criteria established by the collateral manager 334.

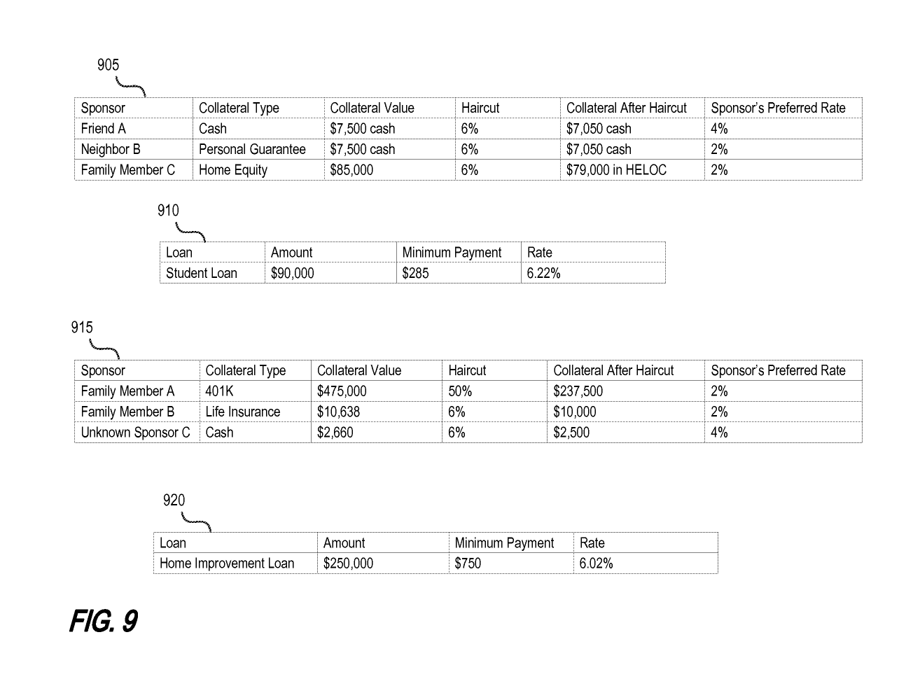

In one implementation, the sponsor response tracking module may detect when the aggregate value of the collateral from the borrower's sponsor network meets or exceeds a threshold value for securing the loan. The borrower's sponsor network includes only those potential sponsors who meet the sponsor and collateral verification criteria. Considering the example of tables 905 and 910 of FIG. 9, the borrower has requested a $90,000 loan, and the borrower's sponsor network includes three sponsors (e.g., Friend A, Neighbor B and Family Member C). After determining the collateral value (e.g., by the collateral manager 334), and taking a haircut of, for example, 6%, the aggregate collateral value after the haircut from the sponsor network is equivalent to $93,100. When the sponsor response tracking module 326 detects that the aggregate collateral value after the haircut from the sponsor network is equal to or greater than the loan amount, the borrower's loan is deemed fully secured, resulting in a secured loan product which can be offered to lenders for purchase or investment. In one implementation, the sponsor response tracking module generates notification for the borrower and/or potential sponsors who have not responded to the sponsorship request that the loan is fully secured, and that additional collateral is no longer required.

The collateral manager 334 is responsible for verification, valuation, monitoring and/or liquidation of collateral provided by the potential sponsors. In one embodiment, the sponsor module 322 may provide the collateral information received from the potential sponsors to the collateral manager 334 for verification. The collateral verification module 336 may, for example, verify each collateral asset with the respective collateral issuing or related agencies or financial institutions. For example, if a potential sponsor offers cash as collateral, the collateral verification module 336 can contact the potential sponsor's bank to verify that the potential sponsor has the specified amount of cash in his or her account. In another implementation, if the collateral is a line of credit, the collateral verification module 336 can verify the line of credit amount from the line of credit issuing financial institution or from credit reporting agencies.

In one implementation, the collateral manager 334 may include a monitoring module 338 that is responsible for initial collateral valuation and subsequent collateral monitoring. In one implementation, the collateral monitoring module 338 may use market data from financial information services such as Markit, Bloomberg and the like to estimate or appraise the fair market value of the asset being used as a collateral for the borrower's loan. In another implementation, instead of the fair market value, the collateral value may be based on the collateral asset's liquidation or fire sale value. In another implementation, the collateral monitoring module 338 may obtain estimated collateral valuation data from external collateral valuation service providers (e.g., collateral service agent 162). The collateral valuation data may encompass assets in various markets such as the equity, interest rate, currency, commodity, credit, property, bonds and the like. The collateral monitoring module 338 may take a haircut from the fair market value or the fire sale value of the collateral (e.g., estimated in-house or obtained from external valuation service providers), to determine the collateral value for securing the loan. For example, if the collateral is cash, a smaller haircut (e.g., 6%) may be taken from the fair market or fire sale value. However, if the collateral has a higher risk, then a larger haircut (e.g., 50% for 401K as collateral) may be taken. The collateral monitoring module 338, in one implementation, communicates the collateral value after the haircut to the sponsor response tracking module 326.

The collateral monitoring module 338 is also responsible for monitoring the value of the collateral originating from the sponsor network, on a daily, weekly, monthly or other periodic basis. In addition to monitoring the collateral value, the collateral monitoring module 338 may, in one implementation, verify that the ownership of the collateral has not changed, or that the collateral has not been revoked. In the event that the collateral monitoring module 338 detects a collateral shortfall, or any other changes that may affect the value or liquidity of the collateral, the module may generate an alert or notification to the responsible sponsor and borrower and/or the collateral liquidation module 340.

The collateral liquidation module 340 is responsible for initiating and/or processing liquidation of collateral in the event of a default or collateral shortfall, as determined by a default handling module 342, or the collateral monitoring module 338 respectively. In one implementation, the collateral liquidation may be outsourced to collateral liquidation agencies.

One embodiment of the OSLM server 130 includes a lender module 332 for obtaining lender information 312 and processing the lender information to verify the lender. Lender information may include, but is not limited to: name, address, social security number, telephone number, email address, bank account/routing number, and the like. The lender module 332 may perform a background or credit check on the lender to verify that the lender is qualified. In one implementation, the lender module 332 may also provide one or more user interfaces, such as the user interface 850 of FIG. 8B, to allow lenders to view and select secured loans to fund at different rates of return, and/or purchase loans from other lenders of the OSLM system. In a further implementation, the lender module 332 may track the lender's investment portfolio. In some implementations, the lender module 332 may also generate recommendations for investment or other opportunities (e.g., an opportunity to be a sponsor) based on lender's investment history and/or preference settings.

Another embodiment of the OSLM server 130 includes a loan fulfillment module 330 for tracking and/or managing funding of secured loans. The loan fulfillment module 330 may also match the loans with lenders to fund the secured loans. For example, in one implementation, the loan fulfillment module 330 keeps track of all unfunded or partially funded loans, and offers such loans to potential lenders. If funding of any loans includes a time constraint (e.g., loan needed in 1 month), the loan fulfillment module 330 may also keep track of the time left to fund the secured loan. When a secured loan is fully funded, the loan fulfillment module 330 notifies the transaction manager 356 to complete the secured lending transaction and provide the borrower the requested loan.

The transaction manager 356 in one embodiment facilitates execution of various agreements between the OSLM (e.g., the SPV) and the sponsors in the borrower's sponsor network, the lender, and the borrower. In one implementation, all of the agreements are executed electronically, with each party receiving agreement documentation electronically.

In one embodiment, the transaction manager 356 may facilitate execution of a collateral agreement by each sponsor in the sponsor network. The collateral agreement is between the sponsor and the OSLM SPV. When a sponsor enters into a collateral agreement with OSLM SPV, the sponsor agrees to provide assets to be used as collateral for a loan made to the borrower by a lender. In one implementation, the collateral agreement may stipulate certain criteria to be used by the OSLM when making loans to borrowers. The transaction manager 356 may provide the sponsors documentation of any loan made to the borrower and certify that the lending criteria stipulated in the collateral agreement are met.

In another embodiment, the transaction manager 356 may facilitate execution of a funding agreement by the lender funding the loans. The funding agreement is between the lender and the OSLM SPV. The funding agreement obligates the lender to provide funding against certain assets held as collateral. The funding agreement may specify, for example, assets acceptable for collateral, acceptable collateral value, haircuts to be used for valuation purposes, acceptable loan-to-value (LTV) ratios, call levels to be used to bring collateral value/LTVs to acceptable levels, and the like. In one implementation, the transaction manager 356 may provide the lender with documentation of interest in collateral held to support funding.

The transaction manager 356 may also include a note issuer module 358 and an account opening module 360 in an embodiment to complete the secured lending transaction. For example, when the loan requested by a borrower is fully secured and funded, the transaction manager 356 may obtain a confirmation from the borrower to complete the transaction. The transaction manager 356 may also facilitate execution of a loan agreement by the borrower to receive the loan. The loan agreement is between the borrower and the OSLM SPV, whereby the borrower agrees to borrow funds and pay interest and repay principal. When the transaction is completed, the OSLM server 130 may generate a response 314 indicating approval of the loan request to the borrower.

The account opening module 360 may request a trust bank (e.g., trust bank 150) to create accounts for all parties, and provide instructions to the trust bank to fund a lender account with funds from the lender (e.g., by authorized withdrawal from lender's bank account having funds, a check deposit, etc.) and each sponsor account with collateral from the sponsor. The note issuer module 358 may issue an executed promissory note or another negotiable instrument to the lender in the amount of the loan requested by the borrower to complete the secured lending transaction.

One embodiment of the OSLM server 130 also includes an accounting manager 346 having a payment allocation module 348, a payment tracking module 350 and a statement reporting module 352 to facilitate allocation, and distribution of fees and other payments to the parties involved in the secured lending transaction.

The payment tracking module 350, in one implementation, may keep track of payment due dates, status of payments from the borrower, determine payments to be made to the lender, sponsors and/or other parties, and provide instructions to the trust bank to process the payments. The payment tracking module 350 may further detect when payments are past due date, and/or a grace period, and notify the default handling module 342 to initiate default handling procedures, such that the lender can recoup the amount of the defaulted loan.

The payment allocation module 348 may be responsible for apportioning payment received from the borrower for distribution to the sponsors, lenders, and the OSLM according to a predefined allocation scheme. In one implementation, the allocation scheme may itself be determined by the payment allocation module 348. For example, based on the size of the loan, or a risk factor consideration, the payment allocation module 348 may generate a payment allocation scheme that specifies the interest rate on the loan, and how that interest rate payment is apportioned among the sponsors, lenders and the OSLM. In an alternate implementation, a default payment allocation scheme may be generated and applied to secured loan transactions. In yet another implementation, a recommended payment allocation scheme may be generated, which can be modified based on sponsor or lender requirements, negotiation, and/or agreement.

In one implementation, for example, the allocation scheme may indicate that the borrower is to pay 8% APR on the loan, the lender (or a group of lenders) is to receive a return corresponding to 4% APR, the sponsor network is to receive a fee corresponding to 2% APR and the OSLM is to receive a fee corresponding to 2% APR. The payment allocation module may apportion, based on the payment allocation scheme for the secured loan transaction, the payment received from the borrower among the lender, sponsors and OSLM, and instruct the trust bank to transfer funds based on the apportionment to the respective accounts.

The statement reporting module 352 may, in one implementation, generate for the borrower, the lender and the sponsors, statements regarding payments on a periodic basis. For example, the statement reporting module 352 may generate for the borrower a monthly statement detailing the payment amount due, the payment due date, a grace period, penalty for late payment, and/or the like. For the sponsors and the lender, the statement reporting module 352 may generate payment statements detailing payment amount deposited in the respective accounts.

One embodiment of the OSLM server 130 may include a sponsor swap module 364. The sponsor swap module allows a borrower to replace one or more sponsors from his or her sponsor network with one or more new sponsors. The replacement may be necessitated by various events, such as a sponsor's desire to be released from the collateral agreement, death, bankruptcy or other life changing events. In one implementation, a sponsor can be released from the collateral agreement only after a new sponsor has been found and verified, and the new sponsor agrees to enter into a collateral agreement with the OSLM. In a further implementation, release and/or entry of a new sponsor may invalidate the previously agreed upon payment allocation scheme, and a new payment allocation scheme may be generated.

Another embodiment of the OSLM server 130 includes a default handling module 342 that is responsible for detecting, initiating and/or processing a default by the borrower. The default handling module 342, for example, via the payment tracking module 350, detects when a loan is in default. If a payment on the loan is not made within a specified time period (e.g., 90 days from the due date), a default condition may arise. The default handling module 342 may send notices to the parties involved (i.e., the borrower, sponsors and lenders) via the statement reporting module 352, for example, to inform the parties involved of options for handling the default. For example, in one implementation, the one or more of the parties may pull out, agree to an extension, and the like. At the end of the extension period if the default is not remedied, or the parties decide to pull out, the default handling module 342 may generate and send instructions to the trust bank to sell the sponsors' assets to generate proceeds. The default handling module 342 may also determine the amount owed to the lenders, and instruct the trust bank to transfer the amount owed from the proceeds generated to the lenders' accounts to cover the default. The module 342 may then apportion any remaining proceeds among the sponsors according to their contribution. The module 342, following settlement of the secured loan, reports the borrower to appropriate credit agencies (e.g., 160) for defaulting on the secured loan.

In addition to direct lending, where a lender or a group of lenders provide funds for a single loan, some embodiments of the OSLM server 130 support pooling of loans and allow lenders to fund loan pools. The OSLM server 130, in a further embodiment, allows structuring or securitization of a loan or a pool of loans, and selling of such securitized loans or loan pools to lenders or loan buyers via a loan securitization module 366. The securitized loan product may be in the form of bonds, pass-through securities, collateralized debt obligation (CDO), and the like. The loan securitization module 366, in one implementation, is responsible for determining and assigning credit ratings and pricing the securitized loan products for sale. The principal and interest on the underlying loans may be used for making payments to the loan buyers, and the sponsors.

The OSLM server 130 may also include an authentication module 362 that creates and manages user accounts (e.g., borrower, sponsor and lender accounts) and authenticates such accounts based on one or more factors of authentication (e.g., using user name and password, location, one time password, telephone verification, and the like) to provide the account holders access to the website hosted by the OSLM server 130.

Depending on the implementation, one or more of the modules 316-366 may be implemented in software, hardware, or a combination thereof. One or more of the modules 316-366 described above may be consolidated into a single module. In some embodiments, additional or less modules may be present in the OSLM server 130. For example, the OSLM server 130 may also include one or more cryptography modules that perform cryptographic operations (e.g., encryption, decryption, digital signing, and the like) on data that is stored in or read out of the one or more database components (e.g., database tables 368-382) and/or exchanged with other modules, components and/or devices. The cryptography modules may apply any suitable cryptography algorithms such as, but not limited to: Advanced Encryption Standard (AES), Secure Hash Algorithm 1 or 2 (SHA-1 or SHA-2), Message Digest 5 (MD5), and/or the like.

One of more of the modules 316-366 may be connected to or in communication with one or more of the databases and/or database tables 368-382 to execute queries, such as those written in Python, PhP, SQL, and the like, to retrieve and/or store data. The borrower account database table 368 includes various data fields such as, but not limited to: borrower ID, name, address, social security number, telephone number, email address, primary bank information, primary bank account number, trust bank account number, loan ID, and the like. The sponsor account database table 370 includes various data fields such as, but not limited to: sponsor ID, sponsor network ID, loan ID, collateral ID, name, address, social security number, email address, telephone number, primary bank information, primary bank account number, trust bank account number, sponsor status, and the like. The lender account database table 372 includes various data fields such as, but not limited to: lender ID, loan ID, name, address, social security number, telephone number, email address, bank account/routing number, and the like. The trust bank database table 374 includes various data fields such as, but not limited to: borrower trust bank account number, sponsor trust bank account number, lender trust bank account number, transaction ID, and the like. The collateral database table 376 includes various data fields such as, but not limited to: collateral ID, transaction ID, collateral value, collateral valuation date, collateral status, collateral type, haircut, and the like. The loan database table 378 includes various data fields such as, but not limited to: loan ID, loan status (active, not active, default), borrower ID, lender ID, sponsor ID, loan amount, loan period, loan start date, load end date, loan purpose, transaction ID, and the like. The transaction account database table 380 includes various data fields such as, but not limited to: transaction ID, loan ID, note ID, transaction date, transaction status, and the like. The accounting account database table 382 includes various data fields such as, but not limited to: loan ID, payment status (e.g., late payment, current payment, delinquent), minimum payment, rate, sponsor amount, lender amount, fee amount, and the like.

### Example Processing

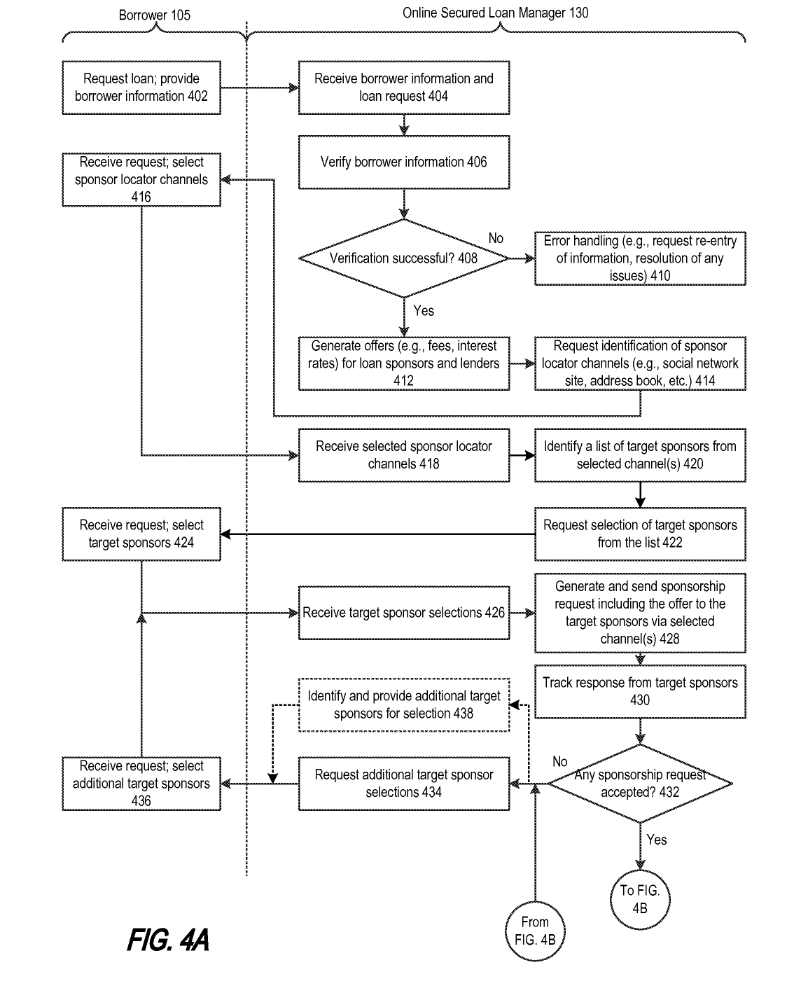

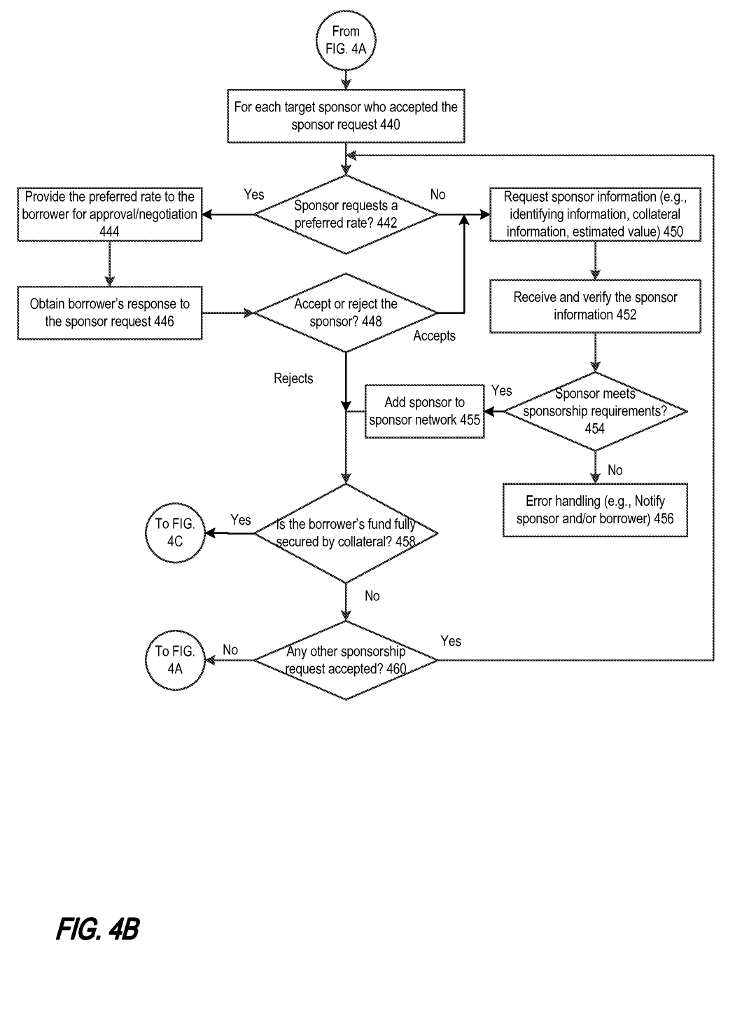

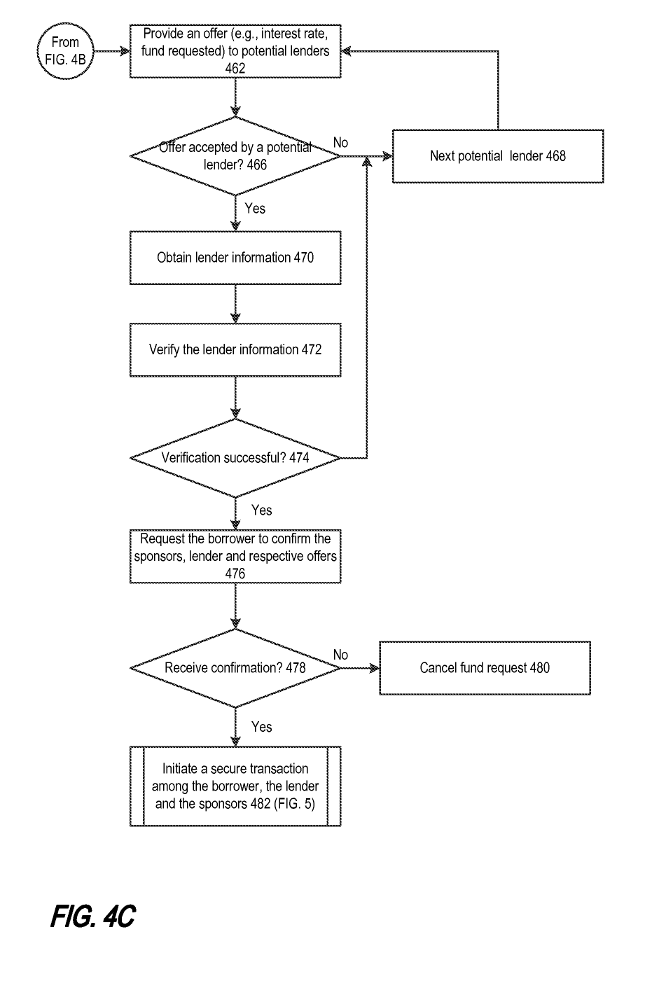

An exemplary method of loan request processing and sponsor selection in the OSLM system is illustrated by the logic flow diagram of FIGS. 4A-B. Referring to FIG. 4A, at block 402, a borrower requests a loan from the OSLM via the OSLM website or mobile application. The request includes borrower information such as, but not limited to: name, address, social security number, telephone number, email address, bank account information, authorization for the OSLM to perform a background or credit check, and the like. The loan request may also include information on the requested loan, such as, but not limited to: loan amount, loan period, purpose for borrowing, and the like.

The OSLM server 130 receives the borrower information and the loan request at block 404. The OSLM server 130 extracts the details of the borrower information, and verifies the information at block 406. The verification process may include communication with external parties or agencies such as the credit reporting agencies, banks, and the like. At decision block 408. the OSLM server 130 determines whether the verification is successful or not. If the verification of borrower information 408 is incomplete or unsuccessful, error handling procedures may be initiated at block 410. For example, the OSLM server 130 may request re-entry of information that does not match what is in the public records, entry of additional information for verification, completion of action items to resolve any verification issues, and/or the like. Alternately, if the verification is determined to be successful at decision block 408, the OSLM server 130 generates an offer for the requested loan at block 412. The offer includes fees and/or interest rates payable by the borrower and the fees and/or interest rates that will be provided to the potential loan sponsors and lenders. For example, the offer includes a base portion that constitutes the fee for the OSLM services, a lender portion that is payable to the lender for providing funds for the loan and a sponsor portion that is payable to the sponsors for providing collateral for the loan. The base portion of the offer may be non-negotiable or negotiable. In one implementation, the base portion of the offer may be determined based on one or more risk criteria. Similarly, the lender and sponsor portions of the offer may be negotiable or non-negotiable. In some implementations, the offer may include both negotiable and non-negotiable portions, such that the total amount or interest rate payable by the borrower remains unfinalized until the lenders and the sponsors enter into an agreement with the OSLM via the SPV. The offer, in one implementation, is the payment allocation scheme. The offer may be specific to the borrower, and in one implementation, is valid for a given time period, loan amount, and/or purpose. The offer may also have a life time (e.g., 24 hours), within which the borrower must enter into an agreement with the OSLM to lock in the given interest rate. In some implementations, more than one offer may be presented, and when multiple offers are presented, the borrower may select one or more of the presented offers for consideration by the potential sponsors and/or lenders.

In one embodiment, the OSLM server 130 may generate a special offer that allows the borrower to enter into a forced savings agreement, where a portion of any payment the borrower makes is automatically deposited in an account such as a savings account, an investment account, and the like. The funds in the savings account may be used for curing non-payment of a loan in one implementation. In another implementation, the funds in the savings account may not be available for withdrawal for a period of time, thereby forcing the borrower to save. For example, a borrower who is paying 18% APR on a credit card debt may receive an offer from the OSLM at 6% APR (with 2% APR going to the sponsors, 2% to the lender, and 2% to the OSLM), subject to sponsor and/or lender agreement with the rates provided. If the borrower desires to enter into a forced savings agreement, an offer at 9% APR may be generated, where an amount corresponding to 3% APR is deposited in a savings account periodically.

At block 414, the OSLM server 130 requests identification of sponsor locator channels such as a social network site, address book, invite, OSLM website, and/or the like. The borrower 105 receives the request at block 416 and selects one or more desired sponsor locator channels. For example, the borrower can select the Facebook as one channel and Gmail contacts as another channel. At block 418, the OSLM server 130 receives the borrower's selection of sponsor locator channels and uses the selected channels to identify a list of target sponsors at block 420. For example, the OSLM server 130, connects to the Facebook using the borrower's authentication credentials, and obtains a list of friends that the borrower can select from. Similarly, the OSLM imports contacts from the borrower's Gmail account, using the borrower's authentication credentials. The OSLM server 130 provides the list of target sponsors for selection by the borrower at block 422. The borrower, at block 424, receives the list, makes one or more selections, and provides the selections to the OSLM server 130.

At block 426, the OSLM server 130 receives the target sponsor selections from the borrower. At block 428, the OSLM server 130 generates and sends sponsorship requests, including the applicable offer portion details, to the selected target sponsors. The OSLM server 130, in one implementation, sends the sponsorship requests using the channel that was used to select the target sponsors. For example, if the sponsorship requests are to be sent to the borrower's Facebook friends, the sponsorship request may be sent via the Facebook platform (e.g., Facebook message, wall post, etc.).

At block 430, the OSLM server 130 tracks responses to the sponsorship requests from the target sponsors. At decision block 432, if a sponsorship request is accepted, the process moves to block 440 of FIG. 4B. If, however, no response is received or accepted within a certain time period, the OSLM server 130 requests additional target sponsor selections, using the previously selected channels or new channels at block 434. Alternately, the OSLM server 130 may identify and provide additional target sponsors for selection at block 438. The OSLM server 130 identified target selections may include target sponsors known to the borrower (e.g., from borrower selected channels) and/or target sponsors unknown to borrowers, such as other users of the OSLM system who are interested in sponsoring loans in exchange for fees. At block 436, the borrower receives the request and proceeds to select additional target sponsors, which are then provided to the OSLM server 130.

Referring to FIG. 4B, the OSLM server 130 may evaluate each target sponsor who accepted the sponsorship request at block 440. In one implementation, at decision block 442, the OSLM server 130 examines the sponsor response to determine if a preferred rate or fee arrangement is requested by the target sponsor. If there is no preferred rate/fee arrangement, the OSLM server 130 requests sponsor information from the target sponsor at block 450. The sponsor information, in one implementation, may include identity information such as the target sponsor's name, address, social security, email, phone, and the like. The sponsor information may also include information on the collateral that the target sponsor is pledging to secure the borrower's loan.

Alternately, if at decision block 442, the target sponsor requests a preferred rate/fee arrangement, the OSLM server 130 provides the preferred rate/fee arrangement to the borrower for approval or negotiation at block 444. At block 446, the OSLM server 130 obtains the borrower's response to the sponsor's rate request. At decision block 448, the OSLM server 130 decides whether to accept or reject the target sponsor based on the borrower's response (e.g., borrower and target sponsor agree on a rate). If the target sponsor is accepted, the OSLM server 130 requests the target sponsor's information at block 450. Conversely, if the target sponsor is rejected, the OSLM server 130, at decision block 458, determines if the borrower's loan is fully secured by collateral from various sponsors. The determination at decision block 458 is based on collateral valuation information provided by the collateral manager 334, for example. If the loan is fully secured, the OSLM server 130 proceeds to block 462 of FIG. 4C. If the loan is not fully secured, and if there are other sponsor responses waiting to be reviewed, as determined at decision block 460, the process moves to block 442 for evaluation of the next target sponsor. However, if the loan is not fully secured, and there are no other sponsor responses waiting to be reviewed, the OSLM server 130 requests additional target sponsor selection from the borrower at block 434 of FIG. 4A.

When the target sponsor accepts the sponsorship request and the offer, with or without a preferred rate, the OSLM server 130 requests sponsor information at block 450. The OSLM server 130 verifies the received information at block 452, using any of the previously discussed methods. At decision block 454, the OSLM server 130 determines, based on the verification results and the collateral information for example, if the target sponsor meets the sponsorship requirements. If the target sponsor fails to meet the sponsorship requirements (e.g., target sponsor's collateral valuation is below the minimum threshold required, etc.), the OSLM server 130 initiates error handling procedures at block 456. For example, the OSLM server 130 may notify the target sponsor and/or the borrower that the target sponsor did not meet the qualification requirements. In one implementation, the OSLM server 130 may provide the target sponsor an opportunity to remedy any deficiency (e.g., put up additional collateral if the reason for the disqualification is collateral not accepted by the OSLM server 130). Conversely, if the target sponsor meets the sponsorship requirements, the OSLM server 130 adds the target sponsor to the sponsor network at block 455, and proceeds to evaluate if the collateral from the sponsor network is enough to secure the loan in full at decision block 458.

The processing of target sponsor responses and sending of sponsorship requests to additional target sponsors may continue until the borrower's loan is fully secured by the collateral from the target sponsors that are accepted by the OSLM server 130 and/or the borrower, in one implementation. In another implementation, if the borrower's loan is not fully secured at the rate desired by the borrower or within a given time frame, the OSLM server 130 may allow the borrower to modify his or her offer to make it more attractive to target sponsors considering pledging collateral for the borrower's loan.

An exemplary method of offering a secured loan to a lender is illustrated by the logic flow diagram of FIG. 4C. When a loan is fully secured by the borrower's sponsor network, the OSLM server 130 posts the secured loan and associated details on the OSLM website to attract potential lenders. Most or all of the secured loans that need funds may be searched by interested lenders using the user interface (e.g., user interface 850 of FIG. 8B) provided by the OSLM server 130. Alternately, the borrower may have the option to selectively publish the loan details (e.g., by messaging within the OSLM website) to potential lenders who meet a certain criteria.

When a lender submits an interest to contribute funds for a loan by selecting a loan and inputting a contribution amount (e.g., a portion or full value of the loan), the OSLM server 130 provides an offer (e.g., lender portion of the offer) to the lender at block 462. At decision block 466, if the offer is not accepted by the potential lender, the OSLM server 130 may allow the lender to negotiate with the borrower to select a different rate, or the lender may provide a counter-offer. Alternately, the OSLM server 130 may reject the offer and proceed to evaluate the next potential lender at block 468. If, on the other hand, at decision block 466, the offer is accepted by a potential lender, the OSLM server 130 obtains lender information from the potential lender at block 470. The lender information may include, but is not limited to: name, address, social security number, telephone number, email address, bank account/routing number, and the like. At block 472, the OSLM server 130 verifies the lender information by, for example, performing a background or credit check on the lender, examining public records, examining banking history, funds in the bank account, and/or the like. If the verification is determined to be incomplete or unsuccessful at decision block 474, the OSLM server 130 may reject the potential lender and move on to the next potential lender at block 468. In one implementation, depending on the reason for incomplete or failed verification, the OSLM server 130 may allow the lender to address any issues for reconsideration.

If the verification is determined to be successful, and assuming that lender is funding the whole of the secured loan, the OSLM server 130 requests the borrower to confirm the sponsors, the lender and the respective offers to the sponsors, the lender and the OSLM server 130 at block 476. The OSLM server 130, in one implementation, may require the lender to enter into a lending agreement with the OSLM server 130 upon successful verification. In a further implementation, the lending agreement may be time-limited, such that if the transaction does not occur within a predefined time period, the lending agreement becomes invalid.

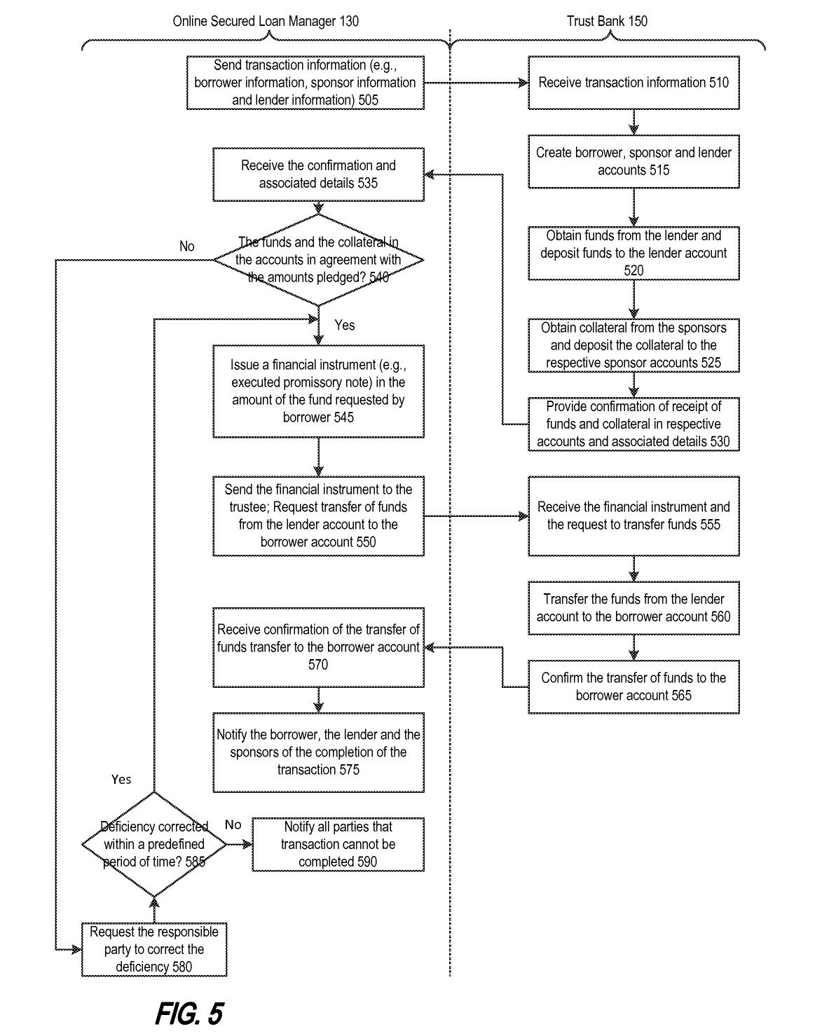

At decision block 478, if the OSLM server 130 receives confirmation from the borrower to proceed with the transaction, the OSLM initiates a secure transaction among the borrower, the lender and the sponsors at block 482. The details of the transaction is discussed with respect to FIG. 5. Alternately, if the borrower fails to provide a confirmation to proceed with the transaction within a predefined time period (e.g., 24 hours), or rejects the transaction as determined at block 478, the OSLM server 130 cancels the loan request at block 480. In one implementation, the borrower may be charged a processing fee, regardless of whether the transaction goes through or not.

In instances where a lender partially funds a loan, each lender may enter into a lending agreement with the OSLM via the SPV. The transaction, however, may be initiated only when additional lenders are located and the loan is fully funded.

An exemplary method of executing a secured loan transaction is illustrated in the logic flow diagram of FIG. 5. Following confirmation from the borrower to proceed with the transaction, the OSLM server 130 sends transaction information to the trust bank 150 at block 505. The transaction information may include information such as, but not limited to: some or all of the borrower information 302, the sponsor information 310, the lender information 312, and the like. The transaction information may also include information relating to collateral provided by the sponsors, in one implementation. At block 510, the trust bank 150 receives the transaction information, and creates accounts for the borrower, the sponsors and the lender at block 515. The trust bank 150 may also obtain, withdraw or cash in funds from the lender and deposit the funds to the lender account at block 520. At block 525, in one implementation, the trust bank 150 may obtain collateral from the sponsors and deposit the collateral to the respective sponsor accounts. At block 530, the trust bank 150 may provide a confirmation of receipt of the funds and collateral in respective lender and sponsor accounts to the OSLM server 130.

At block 535, the OSLM server 130 may receive the confirmation from the trust bank 150. The OSLM server 130 may also receive the details of the funds transferred and item and/or values of the collateral in the sponsor accounts. At decision block 540, the OSLM server 130 may verify, whether the funds and collateral in the accounts at the trust bank 150 match the funds and collateral specified on the lender agreement and the collateral agreement respectively. If there is a discrepancy, the OSLM server 130 requests the responsible party to correct any deficiency at block 580. If the deficiency is not corrected with a given time period, as determined at decision block 585, the OSLM server 130 cancels the transaction at block 590, and notifies all parties that the transaction cannot be completed.

If, however, there are no discrepancies at decision block 540 or if any deficiency is corrected with the given time period at decision block 585, the OSLM server 130 issues a financial instrument, such as an executed promissory note in the amount of the loan requested by the borrower at block 545. The OSLM server 130 sends the financial instrument to the trust bank 150, along with a request to transfer funds for the loan from the lender account to the borrower account at block 550.

The trust bank 150 receives the financial instrument and the request to transfer the funds for the loan at block 555. The trust bank 150 processes the request at block 560, and provides a confirmation to the OSLM server 130 at block 565. The OSLM server 130 receives the confirmation at 570 and at block 575, notifies the borrower, the lender and the sponsors that the transaction is completed.

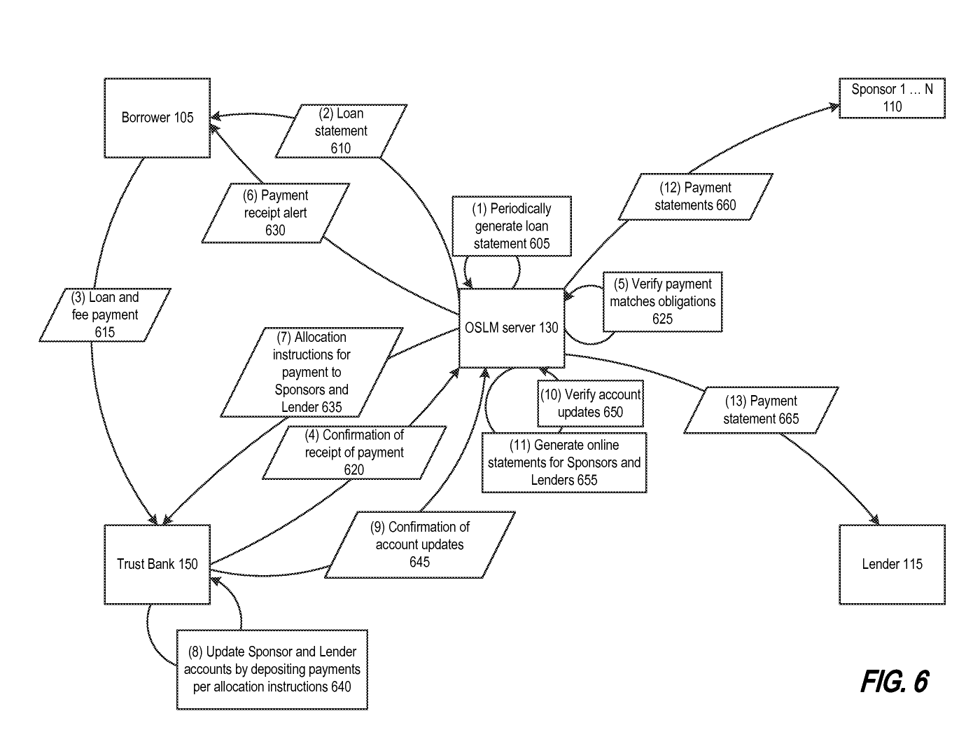

In one embodiment, the OSLM server 130 monitors the payment on the loan provided to the borrower. The OSLM server 130 also ensures that the sponsors and the lender receive the payment owed. An exemplary flow of payments is illustrated in the data flow diagram of FIG. 6. The messages that are exchanged between the OSLM server 130 and the borrower 105, the sponsors 1-N 110, lender 115 and the trust bank 150 may be Secure Hypertext Transfer Protocol (HTTPS) messages formatted in XML, for example, and including transport layer security (TLS), secure sockets layer (SSL), or the like.

The OSLM server 130 periodically generates a loan statement at block 605 including the payment amount due, and the due date via the accounting manager 346 for example. The payment amount due may be a combination of interest rate and/or fees and a portion of the principal. The OSLM server 130 sends the loan statement 610 electronically over a network to the borrower 105. The loan statement 610 may also be accessed by the borrower 105 by logging in to the OSLM server 130 website or using a mobile application. The borrower 105 then makes a loan payment 615 to the trust bank 150. The loan payment 615 may be made electronically, using direct deposit, bill pay, money transfer or any other methods of electronic payment transfer. The loan payment 615 may include interest payment on the loan, and fees payable to the OSLM and the sponsor network. The trust bank 150 receives the loan payment 615 and provides a confirmation message 620 to the OSLM server 130 indicating receipt of payment and the amount of the payment from the borrower 105. The OSLM server 130 matches the amount of the payment received to the borrower's payment obligation and schedule at 625, and sends a payment receipt alert message 630 to the borrower 105.

The OSLM server 130 then sends allocation instructions 635 for payment to the sponsors and the lender to the trust bank 150. The trust bank 150 uses the allocation instructions to transfer funds to the sponsor and lender accounts at 640. The trust bank 150 then sends a confirmation message 645, including the amounts transferred to the sponsor and lender accounts to the OSLM server 130. At 650, the OSLM server 130 verifies that the transferred amounts match the allocation instructions. The OSLM server 130 then generates electronic statements for the sponsors and the lender, indicating the deposit of funds at 655. The OSLM server 130 then sends the payment statements for the sponsors in a message 660 to the sponsors. Similarly, the payment statement for the lender is sent in a message 665 to the lender 115. The payment statements may also be available for access or download through the OSLM website/mobile application.

In one embodiment of the OSLM system, default events can arise if the loan payments are not made on time or when there is a collateral shortfall. A collateral shortfall is created when the value of the collateral falls below a threshold amount. In the OSLM system, if the borrower defaults, and the collateral call is not met within a call period or the loan default is not remedied, the collateral is liquidated with proceeds used to repay principal amount due to the lender and any accrued interest. Any excess cash is returned to the sponsors and the note is transferred to the sponsors. If the funds paid to the lender is not sufficient to repay principal and interest due, the OSLM system may sell the note and the unmet collateral call, and the lender has the last right to match the highest bid. The sponsors forfeit all rights and interest in the note. The loan sale proceeds is used to make up the shortfall of principal and interest due to the lender.

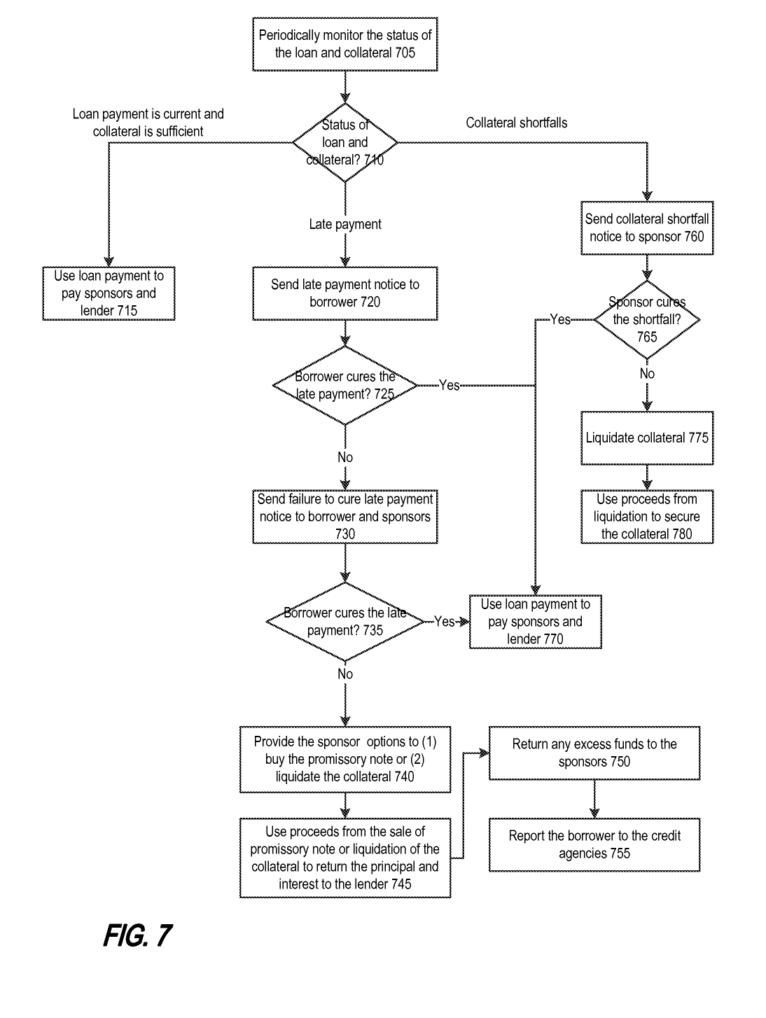

An exemplary method of managing default is illustrated in the logic flow diagram of FIG. 7. In one embodiment, the OSLM server 130 periodically monitors the status of the loan payments and the collateral value at block 705. At decision block 710, the OSLM server 130 makes a determination regarding the status of the loan payments and the collateral value. For example, if the loan payment is current and the collateral value is sufficient (i.e., above the threshold set), the OSLM server 130 continues its activities as usual. At block 715, the OSLM server 130 uses loan payments from the borrower to make payments owed to the sponsors and the lender.

If, at decision block 710, the OSLM server 130 determines that the loan payment is late, the OSLM server 130 sends a late payment notice to the borrower at block 720. The OSLM server 130 may usually give the borrower a grace period to make the payment. At decision block 725, if the OSLM server 130 determines that the borrower has failed to cure the late payment, the OSLM server 130 sends a notice indicating failure to cure the late payment to the borrower and the borrower's sponsor network at block 730. If the borrower does not cure the late payment after the second notice as determined at decision block 735, the OSLM server 130 provides the sponsors an option to buy the promissory note at block 740. Alternately, the OSLM server 130 provides the sponsors an option to liquidate the collateral to cure the default.

At block 745, the OSLM server 130 uses the proceeds from the sale of the promissory note or the liquidation of the collateral to return the lender the principal and any interest accrued. Any excess proceeds is returned to the sponsors at block 750. At block 755, the borrower is reported to one or more credit agencies for defaulting on the loan.

In some implementations, if the borrower cures the late payment upon receiving the first notice, or upon receiving the second notice, the OSLM server 130 does not operate in the default mode. Instead, the OSLM server 130 uses the loan payment to pay the sponsors and the lender at block 770.

Referring to decision block 710, if the OSLM server 130 detects a collateral shortfall, the OSLM server 130 sends a notice to the responsible sponsor in the sponsor network and/or all the sponsors in the sponsor network indicating the collateral shortfall, and the amount of the shortfall at block 760. At decision block 765, if the responsible sponsor cures the shortfall, liquidation of the collateral is averted. However, if the shortfall is not cured, the OSLM proceeds to liquidate the collateral at block 775 and use the proceeds generated from the collateral to secure the loan at block 780.

In one implementation, the OSLM server 130, via the sponsor swap module 364 for example, may notify the borrower when there is a collateral shortfall and give the borrower an opportunity to find a replacement sponsor. Alternately, the sponsor associated with the collateral shortfall or the OSLM server 130 may find a replacement sponsor to take his or her position.

### Example User Interfaces

FIGS. 8A-B are diagrams illustrating exemplary user interfaces of the OSLM server 130. Referring to FIG. 8A, the user interface 805 allows a borrower to find sponsors. The user interface 805 includes various sponsor locator channels such as one or more social network plugins 810 that allow the borrower to access list of users, select potential sponsors and send communication to the sponsors, invite option 815 to enter one or more email addresses of potential sponsors and send an email communication to the potential sponsors, import contacts option 820 that allows the borrower to import contacts from address books and contacts maintained externally in Gmail, Yahoo or other services, option 825 to connect to users of the OSLM website, and the like. When a sponsor locator channel 810 is selected, the user interface may display an address field 830 to enter or select potential sponsors and a message field 835 to write a personal message to the potential sponsors. An OSLM server 130 generated message text 840 with link for accessing the OSLM website may be appended to any message sent to potential sponsors.

Referring to FIG. 8B, example user interface 850 allows a lender to select loans for investment. A list of secured loans 855 that are unfunded or partially funded is displayed, along with details such as the term of the loan, amount of the loan, percentage of the loan already funded, time left to fund the loan, amount the lender desires to use to fund the loan, the rate of return, and the like. The user interface 850 includes tools to filter loans based on one or more criteria (e.g., student loan and amount less than $5000) or search for loans available for funding. The user interface 850 may also include a portfolio summary section 860, where the lender's portfolio of investments made using the OSLM system in various loan products are graphically displayed. The user interface may also include portfolio diversification section 865 that provides options for the lender to become a sponsor, diversify the current portfolio by investing in different types of loans, and the like. The OSLM server 130 may identify diversification opportunities based on the lender's current portfolio allocations, investment history, and available loan options.

Exemplary secured loans available from the OSLM system are illustrated by tables 905-910 and 915-920 in FIG. 9. Table 905 lists a sponsor network, the collateral type, haircut, the collateral value before and after the haircut and the sponsors' preferred rates for the loan securing portion of an example transaction. Table 910 lists the details of an example loan secured by the sponsor network of table 905. Similarly, table 915 lists another example sponsor network that secures the home improvement loan of table 920.

### Example Computer Systemization

Aspects and implementations of the OSLM system have been described in the general context of computer-executable instructions, such as routines executed by a general-purpose computer, a personal computer, a server, and/or other computing systems such as the OSLM server 130. The OSLM server 130 may be in communication with entities including one or more users (e.g., users 105, 110, 115), client devices 120, user input devices 1002, peripheral devices 1004, an optional co-processor device(s) (e.g., cryptographic processor devices) 1006, and networks 125. Users may engage with the OSLM server 130 via client devices 120 over networks 125.

Computers employ central processing unit (CPU) or processor (hereinafter “processor”) to process information. Processors may include programmable general-purpose or special-purpose microprocessors, programmable controllers, application-specific integrated circuits (ASICs), programmable logic devices (PLDs), embedded components, combination of such devices and the like. Processors execute program components in response to user and/or system-generated requests. One or more of these components may be implemented in software, hardware or both hardware and software. Processors pass instructions (e.g., operational and data instructions) to enable various operations.

The OSLM may include clock 1020, CPU 1022, memory such as read only memory (ROM) 1028 and random access memory (RAM) 1026 and co-processor 1024 among others. These controller components may be connected to a system bus 1018, and through the system bus 1018 to an interface bus 1008. Further, user input devices 1002, peripheral devices 1004, co-processor devices 1006, and the like, may be connected through the interface bus 1008 to the system bus 1018. The Interface bus 1008 may be connected to a number of interface adapters such as processor interface 1010, input output interfaces (I/O) 1012, network interfaces 1014, storage interfaces 1016, and the like.

Processor interface 1010 may facilitate communication between co-processor devices 1006 and co-processor 1024. In one implementation, processor interface 1010 may expedite encryption and decryption of requests or data. Input Output interfaces (I/O) 1012 facilitate communication between user input devices 1002, peripheral devices 1004, co-processor devices 1006, and/or the like and components of the OSLM server 130 using protocols such as those for handling audio, data, video interface, wireless transceivers, or the like (e.g., Bluetooth, IEEE 1394a-b, serial, universal serial bus (USB), Digital Visual Interface (DVI), 802.11a/b/g/n/x, cellular, etc.). Network interfaces 1014 may be in communication with the network. Through the network, the OSLM may be accessible to remote client devices 120. Network interfaces 1014 may use various wired and wireless connection protocols such as, direct connect, Ethernet, wireless connection such as IEEE 802.11a-x, and the like. Examples of network 125 include the Internet, Local Area Network (LAN), Metropolitan Area Network (MAN), a Wide Area Network (WAN), wireless network (e.g., using Wireless Application Protocol WAP), a secured custom connection, and the like. The network interfaces 1014 can include a firewall which can, in some embodiments, govern and/or manage permission to access/proxy data in a computer network, and track varying levels of trust between different machines and/or applications. The firewall can be any number of modules having any combination of hardware and/or software components able to enforce a predetermined set of access rights between a particular set of machines and applications, machines and machines, and/or applications and applications, for example, to regulate the flow of traffic and resource sharing between these varying entities. The firewall may additionally manage and/or have access to an access control list which details permissions including for example, the access and operation rights of an object by an individual, a machine, and/or an application, and the circumstances under which the permission rights stand. Other network security functions performed or included in the functions of the firewall, can be, for example, but are not limited to, intrusion-prevention, intrusion detection, next-generation firewall, personal firewall, etc., without deviating from the novel art of this disclosure.

Storage interfaces 1016 may be in communication with a number of storage devices such as, storage devices 1032, removable disc devices, and the like. The storage interfaces 1016 may use various connection protocols such as Serial Advanced Technology Attachment (SATA), IEEE 1394, Ethernet, Universal Serial Bus (USB), and the like.

User input devices 1002 and peripheral devices 1004 may be connected to I/O interface 1012 and potentially other interfaces, buses and/or components. User input devices 1002 may include card readers, finger print readers, joysticks, keyboards, microphones, mouse, remote controls, retina readers, touch screens, sensors, and/or the like. Peripheral devices 1004 may include antenna, audio devices (e.g., microphone, speakers, etc.), cameras, external processors, communication devices, radio frequency identifiers (RFIDs), scanners, printers, storage devices, transceivers, and/or the like. Co-processor devices 1006 may be connected to the OSLM server 130 through interface bus 1008, and may include microcontrollers, processors, interfaces or other devices.

Computer executable instructions and data may be stored in memory (e.g., registers, cache memory, random access memory, flash, etc.) which is accessible by processors. These stored instruction codes (e.g., programs) may engage the processor components, motherboard and/or other system components to perform desired operations. The OSLM server 130 may employ various forms of memory including on-chip CPU memory (e.g., registers), RAM 1026, ROM 1028, and storage devices 1032. Storage devices 1032 may employ any number of tangible, non-transitory storage devices or systems such as fixed or removable magnetic disk drive, an optical drive, solid state memory devices and other processor-readable storage media. Computer-executable instructions stored in the memory may include the OSLM system 300 having one or more program modules such as routines, programs, objects, components, data structures, and so on that perform particular tasks or implement particular abstract data types. For example, the memory may contain operating system (OS) component 1034, program modules and other components (e.g., 316-366), database tables 368-382, and the like. These modules/components may be stored and accessed from the storage devices, including from external storage devices accessible through an interface bus.

The database components 368-382 are stored programs executed by the processor to process the stored data. The database components may be implemented in the form of a database that is relational, scalable and secure. Examples of such database include DB2, MySQL, Oracle, Sybase, and the like. Alternatively, the database may be implemented using various standard data-structures, such as an array, hash, list, struct, structured text file (e.g., XML), table, and/or the like. Such data-structures may be stored in memory and/or in structured files.

The OSLM server 130 may be implemented in distributed computing environments, where tasks or modules are performed by remote processing devices, which are linked through a communications network, such as a Local Area Network (“LAN”), Wide Area Network (“WAN”), the Internet, and the like. In a distributed computing environment, program modules or subroutines may be located in both local and remote memory storage devices. Distributed computing may be employed to load balance and/or aggregate resources for processing. Alternatively, aspects of the OSLM server 130 may be distributed electronically over the Internet or over other networks (including wireless networks). Those skilled in the relevant art will recognize that portions of the OSLM system 300 may reside on a server computer, while corresponding portions reside on a client computer. Data structures and transmission of data particular to aspects of the OSLM server 130 are also encompassed within the scope of the invention.

### CONCLUSION

The above Detailed Description of embodiments of the invention is not intended to be exhaustive or to limit the invention to the precise form disclosed above. While specific examples for the invention are described above for illustrative purposes, various equivalent modifications are possible within the scope of the invention, as those skilled in the relevant art will recognize. For example, while processes or blocks are presented in a given order, alternative implementations may perform routines having steps, or employ systems having blocks, in a different order, and some processes or blocks may be deleted, moved, added, subdivided, combined, and/or modified to provide alternative combinations or subcombinations. Each of these processes or blocks may be implemented in a variety of different ways. Also, while processes or blocks are at times shown as being performed in series, these processes or blocks may instead be performed or implemented in parallel, or may be performed at different times.

In general, the terms used in the following claims should not be construed to limit the invention to the specific examples disclosed in the specification, unless the above Detailed Description section explicitly defines such terms. Accordingly, the actual scope of the invention encompasses not only the disclosed examples, but also all equivalent ways of practicing or implementing the invention under the claims.

From the foregoing, it will be appreciated that specific embodiments of the invention have been described herein for purposes of illustration, but that various modifications may be made without deviating from the spirit and scope of the invention. Accordingly, the invention is not limited except as by the appended claims.

1. A processor-implemented method of a social network facilitated secured lending transaction, comprising:
receiving via a processor a request for a loan from a borrower, wherein the request for the loan includes borrower information and specifies at least one channel for locating sponsors;
sending via the processor sponsorship requests to sponsors located via the at least one channel;
receiving from at least some of the sponsors acceptance responses to the sponsorship requests;
obtaining information on collateral pledged by sponsors providing the acceptance responses;
determining via the processor a market value of the collateral pledged by each of the sponsors;
determining via the processor that the market value of the collateral pledged by each of the sponsors is sufficient to secure a portion of the loan;
securing the loan by allocating the collateral pledged by each of the sponsors to the corresponding portion of the loan; and
providing the loan to the borrower when the loan secured by the collateral from the sponsors is funded.

2. The processor-implemented method of claim 1, wherein the collateral includes cash, equities, certificates of deposit, lines of credit, mutual funds, debt instruments, derivative instruments, foreign securities, real estate or hard assets.

3. (canceled)

4. The processor-implemented method of claim 1, wherein the investment offer includes an interest on the loan and a guarantee of payment of the principal and interest of the loan.

5. The processor-implemented method of claim 4, further comprising providing to each sponsor of the loan a sponsor fee for pledging the collateral.

6. The processor-implemented method of claim 5, further comprising determining an amount payable by the borrower for the loan, wherein the amount payable is determined based at least in part on the sponsor fee for each portion of the loan and the interest rate payable to the lender.

7. The processor-implemented method of claim 6, wherein the amount payable by the borrower for the loan includes a processing fee.

8. The processor-implemented method of claim 1, further comprising receiving from the lender a pledge to provide funds for the loan secured by the collateral from the sponsors, wherein the collateral includes personal guarantees or assets.

9. The processor-implemented method of claim 8, further comprising executing a secured loan transaction when the sponsors pledge the collateral to secure the loan, the lender pledges to provide funds for the loan and the borrower agrees to accept the secured loan.

10. The processor-implemented method of claim 9, wherein the executing includes:
providing to a financial institution the borrower information, the sponsor information and lender information to create a borrower account, sponsor accounts and a lender account respectively, wherein:
the sponsor accounts hold the collateral pledged by the respective sponsors;
the lender account holds funds for the loan received from the lender; and
issuing an executed promissory note in the amount of the loan to request transfer of funds from the lender account to the borrower account.

11. (canceled)

12. The processor-implemented method of claim 11, further comprising:
periodically generating an accounting statement that specifies an amount payable by the borrower;
determining whether a payment is received in the borrower account within a time period and if so, verifying whether the payment matches the amount payable specified in the account statement.

13. The processor-implemented method of claim 12, further comprising:
sending allocation instructions to the financial institution for depositing payments to each of the lender account and the sponsor accounts;
periodically generating an accounting statement including interest payment for the lender and an accounting statement including fee for each of the sponsors.

14. The processor-implemented method of claim 12, further comprising:
triggering a default on the loan if a payment is not received in the borrower account within the time period or if the payment does not match the amount payable specified in the account statement; and
notifying the borrower, the lender and the sponsors of the default on the loan.

15. The processor-implemented method of claim 14, further comprising:
liquidating the collateral in the sponsor accounts and using proceeds from the liquidation to pay the principal and interest accrued to the lender; and
transferring the promissory note to the sponsors.

16. The processor-implemented method of claim 1, further comprising:
periodically monitoring the market value of the collateral securing each portion of the loan; and
when the market value of the collateral securing a portion of the loan decreases below a threshold,
requesting the corresponding sponsor to provide additional collateral to secure the portion of the loan.

17. The processor-implemented method of claim 16, further comprising liquidating the collateral to secure the portion of the loan when the sponsor fails to provide additional collateral.

18. The processor-implemented method of claim 16, wherein monitoring the market value of the collateral includes obtaining daily market prices of each security in the collateral and determining the market value of the collateral based on the daily market prices.

19. The processor-implemented method of claim 1, wherein the channel for locating sponsors includes online social network, offline social network, email contacts, phone contacts, professional network or alumni network.

20. The processor-implemented method of claim 10, further comprising:
swapping out an outgoing sponsor of a portion of the loan with a replacement, wherein the replacement is a new sponsor or one of the sponsors of remaining portions of the loan.

21. The processor-implemented method of claim 20, wherein the replacement provides collateral having a minimum market value required to secure to the portion of the loan.

22. The processor-implemented method of claim 21, wherein the swapping out triggers calculation of a new amount payable for the borrower if the replacement selects a sponsor fee different from the sponsor fee selected by the outgoing sponsor.

23. The processor-implemented method of claim 1, the portion of the loan securable by the market value of the collateral is the market value of the collateral after a haircut.

24. A system, comprising:
a memory;
a processor disposed in communication with the memory, and configured to process a plurality of instructions to:
receive a request for a loan from a borrower, wherein the request for the loan includes borrower information and specifies at least one channel for locating sponsors;
send sponsorship requests to sponsors located via the at least one channel;
receive from at least some of the sponsors acceptance responses to the sponsorship requests;
obtain information on collateral pledged by sponsors providing the acceptance responses;
determine a market value of the collateral pledged by each of the sponsors;
determine whether the market value of the collateral pledged by each of the sponsors is sufficient to secure a portion of the loan;
if so, secure the loan by allocating the collateral pledged by each of the sponsors to the corresponding portion of the loan; and
provide the loan to the borrower when the loan secured by the collateral from the sponsors is funded.

25. A processor-readable non-transitory medium storing instructions to:
receive a request for a loan from a borrower, wherein the request for the loan includes borrower information and specifies at least one channel for locating sponsors;
send sponsorship requests to sponsors located via the at least one channel;
receive from at least some of the sponsors acceptance responses to the sponsorship requests;
obtain information on collateral pledged by sponsors providing the acceptance responses;
determine a market value of the collateral pledged by each of the sponsors;
determine whether the market value of the collateral pledged by each of the sponsors is sufficient to secure a portion of the loan;
if so, secure the loan by allocating the collateral pledged by each of the sponsors to the corresponding portion of the loan; and
provide the loan to the borrower when the loan secured by the collateral from the sponsors is funded.

26-34. (canceled)

35. The system of claim 24, further configured to receive from the lender a pledge to provide funds for the loan secured by the collateral from the sponsors, wherein the collateral includes personal guarantees or assets.

36. The system of claim 35, further configured to execute a secured loan transaction when the sponsors pledge the collateral to secure the loan, the lender pledges to provide funds for the loan and the borrower agrees to accept the secured loan.

37. The system of claim 36, wherein the executing includes:
providing to a financial institution the borrower information, the sponsor information and lender information to create a borrower account, sponsor accounts and a lender account respectively, wherein:
the sponsor accounts hold the collateral pledged by the respective sponsors;
the lender account holds funds for the loan received from the lender; and
issuing an executed promissory note in the amount of the loan to request transfer of funds from the lender account to the borrower account.

38. The system of claim 37, further configured to:
swap out an outgoing sponsor of a portion of the loan with a replacement, wherein the replacement is a new sponsor or one of the sponsors of remaining portions of the loan.

39. The system of claim 38, wherein the replacement provides collateral having a minimum market value required to secure to the portion of the loan.

40. The system claim 39, wherein the swapping out triggers calculation of a new amount payable for the borrower if the replacement selects a sponsor fee different from the sponsor fee selected by the outgoing sponsor.

41. The processor-implemented method of claim 24, the portion of the loan securable by the market value of the collateral is the market value of the collateral after a haircut.
